(19) United States
(12) Patent Application Publication
(10) Pub. No.: US 2013/0018805 A1
(43) Pub. Date: Jan. 17, 2013

(54) Method and system for linking information regarding intellectual property, items of trade, and technical, legal or interpretive analysis

(71) Applicant: Eugene M. Lee, Annandale, VA (US)

(72) Inventor: Eugene M. Lee, Annandale, VA (US)

(21) Appl. No.: 13/619,686

(22) Filed: Sep. 14, 2012

Related U.S. Application Data
(63) Continuation of application No. 10/101,749, filed on Mar. 21, 2002.
Application No. 10/101,749 is a continuation-in-part of application No. 09/460,806, filed on Dec. 14, 1999, now Pat. No. 7,016,852.
Application No. 09/460,806 is a continuation-in-part of application No. 09/409,524, filed on Sep. 30, 1999, now Pat. No. 7,016,851.
(60) Provisional application No. 60/277,282, filed on Mar. 21, 2001.
(60) Provisional application No. 60/315,021, filed on Aug. 28, 2001.

(51) Int. Cl. G06Q 99/00

(52) U.S. Cl. 705/310

(57) ABSTRACT

An apparatus for and a method of analyzing intellectual property (IP) is provided. In accordance with a preferred embodiment of the invention, an apparatus (and corresponding method) is provided for linking information regarding intellectual property (e.g., patents, trademarks, copyrights, trade secrets, etc.), items of trade (e.g., products, services, etc.), and analysis (e.g., technical, legal, interpretative, etc.). In an exemplary embodiment, an intellectual property analyzer may be provided with one or more modules (e.g., identifier module, report generator, linking module, etc.) to automatically and manually retrieve, gather, compile, store and process information for performing and reporting analysis of intellectual property.

This application derives from and claims the benefit of both U.S. Provisional Application No. 60/277,282, filed Mar. 21, 2001, and also U.S. Provisional Application No. 60/315,021, filed Aug. 28, 2001, the disclosures of which are hereby incorporated herein by reference in their respective entireties.

### BACKGROUND

The conventional process of assessing intellectual property such as patents, trademarks, and copyrights in an intellectual property portfolio requires intense effort in manually gathering relevant information. An analysis of just one patent involves considerable manual effort gathering information, even prior to a performance of a legal analysis.

Once the information is gathered, each type of intellectual property analysis has a traditional framework for consideration of the information. For example, a patent is analyzed in the framework of a validity analysis or an infringement analysis (or perhaps both). Such analysis involves principally a manual review of the product and the patent concerned. Comments relevant to the intellectual property analysis are traditionally entered into a document, such as an opinion letter, via a word processor.

Such assessments, once complete, historically are awkward or difficult to locate. For example, an opinion letter might be electronically stored as a word processing document, and word processing claim chart or spread sheet. The supporting background information includes disparate items such as patents, publications, and physical products, none of which are integrated into the electronic storage system. As multiple intellectual properties are involved in an analysis, the problem of assessing, storing and retrieving analysis results grows exponentially.

It is not unusual for information or legal authority relevant to an analysis to change, thereby necessitating an updated analysis. It is time-consuming to update a previous analysis. For example, the affected information in a formal opinion may be located in several places. Newly located references may necessitate alterations to portions of the analysis. A modified or entirely new product design might significantly alter much of the analysis. Although it is not unusual for references or background information or designs to be fluid during preparation of an analysis, there is simply no continuity in updating an analysis and the conventional analysis tends to be completely static.

### SUMMARY

An apparatus for and a method of analyzing intellectual property (IP) is provided. In accordance with a preferred embodiment of the invention, an apparatus (and corresponding method) is provided for linking information regarding intellectual property (e.g., patents, trademarks, copyrights, trade secrets, etc.), items of trade (e.g., products, services, etc.), and analysis (e.g., technical, legal, interpretative, etc.). In an exemplary embodiment, an intellectual property analyzer may be provided with one or more modules (e.g., identifier module, report generator, linking module, etc.) to automatically and manually retrieve, gather, compile, store and process information for performing and reporting analysis of intellectual property.

### BRIEF DESCRIPTION OF DRAWINGS

FIG. 1 illustrates a system architecture in accordance with a preferred embodiment of the invention; and

FIGS. 2a and 2b are representational diagrams illustrating exemplary linked relationships between (or among) information regarding intellectual property, items of trade, and analysis.

### DETAILED DESCRIPTION

Preferred embodiments and applications of the invention will now be described. Other embodiments may be realized and structural or logical changes may be made to the disclosed embodiments without departing from the spirit or scope of the invention. Although the preferred embodiments disclosed herein have been particularly described as applied to an apparatus for (and method of) analyzing intellectual property in the form of patents, it should be readily apparent that the invention may be embodied to implement any system (or method) having the same or similar problems.

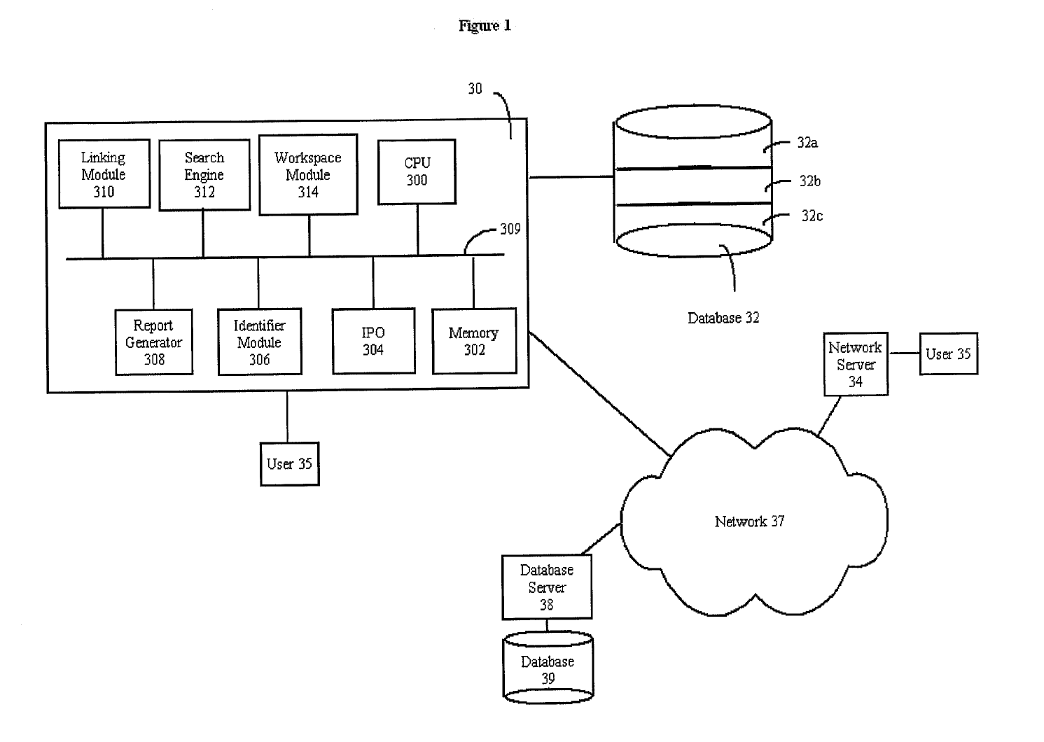

An exemplary system architecture in accordance with a preferred embodiment of the invention is illustrated in FIG. 1. The exemplary system architecture may be used to effectuate any one or more aspects of the intellectual property analysis operations described in (and methods apparent from) the specific embodiments, implementations, and illustrations provided herein.

Some of the many system components that may be employed in the architecture include: one or more analyzer servers (symbolically depicted as “server 30”); one or more logical or physical storage units (symbolically depicted as “database 32”); one or more remote storage units (symbolically depicted as “database 39”); one or more networks (symbolically depicted as “network 37”); and one or more users (symbolically depicted as “user or user interface 35”), as will be described in more detail below.

In accordance with a preferred embodiment, server 30 may include one or more central processing units (CPUs) symbolically represented by CPU 300 used to provide processing of input/output data between server 30, user interface 35, and/or network 37, and among the different modules (all connected together via system bus 309) within server 30. CPU 300, which may be any known (single or multiple) processor or processor-based system, typically executes one or more executable instructions or programs stored in the one or more (local or remote) memory devices or units (or other articles of manufacture) symbolically represented as memory module 302. Individual control modules (e.g., IPO 304, identifier module 306, report generator 308, linking module 310, search engine 312, workspace module 314, etc.) may be provided to control processing of the individual analysis or other operations described in (or apparent from) the instant disclosure, as will be described in detail below. The individual control modules may themselves be processors or processor-based systems executing one or more executable programs (locally or remotely) stored in a memory component (or other article of manufacture).

User interface 35 may include one or more video display devices (e.g., CRT, LCD, plasma or other known visualization devices) or other output devices (e.g., printer, e-mail server, textual/graphic file generator, audio generator, tactile generator, etc.), and one or more input devices (e.g., keyboard, mouse, stylus, touch screen interface, or other known input mechanisms) for facilitating interaction of one or more users with the system via one or more interfaces (e.g., user interface 35). As illustrated, user interface 35 may be directly coupled to server 30, or indirectly coupled to server 30 through one or more interfacing modules (e.g., network server 34) and one or more direct or indirect transmission paths (e.g., symbolically represented as “network 37”).

Network 37 may take any wired/wireless form of known connective technology (e.g., corporate or individual LAN, enterprise WAN, intranet, Internet, Virtual Private Network (VPN), combinations of network systems, PCI (or other internal computer) bus etc.) to allow server 30 to provide local/remote information and control data to/from other locations (e.g., remote database server 38/remote database 39, network server 34/user interface 35, etc.). In accordance with a preferred embodiment of the invention, server 30 may be implemented in stand-alone or network devices, as well as serving one or more users over a collection of remote and disparate networks (e.g., Internet, intranet, VPN, etc.).

In accordance with a preferred embodiment of the invention, information related to intellectual property is stored in database 32 (particularly in storage unit 32a) and/or in one or more remote database systems (e.g., database 39). (For simplicity, reference is made herein only to database 32 or its storage units (e.g., storage unit 32a), although it should be readily apparent that one or more supplementary or alternative storage devices (e.g., remote database 39) may be employed in lieu of (or in combination with database 32) for any given implementation of the invention.) In an exemplary embodiment, the stored intellectual property information is related to patents, including (some or all) of the identifying data and underlying text/images representing patent rights as reflected in U.S., foreign, international, or multi-national patents or patent publications (e.g., issued patents or equivalents, published patent applications, statutory invention registrations, abstracts, etc.), including Japanese, Patent Cooperation Treaty (PCT), and European Convention patent publications, as well as other related information (e.g., technical publications, sequence listings, file histories, government records, public notices, etc.) that may be associated or otherwise pertinent to such patents and publications. The different information may be stored as a continuous set of data records, segmented to form a contiguous whole, or separated into different segments to reside in and among one or more server databases, as well as partitioned for storage in one or more files to achieve efficiencies in storage, access, and processing of data.

The stored intellectual property information may be stored in one or more database structures for use in their raw, natural, or unmodified data states. The stored intellectual property information may be delivered periodically (e.g., updated weekly) from a data source such as from the commercially available Intellectual Property Organizer from Knowledge Management Objects, LLC (symbolically depicted as “IPO module 304”)), or may be dynamically retrieved as needed in real-time (or non-real-time) for temporary/permanent storage in memory module 302 and/or database 32 during any server operation.

In accordance with a preferred embodiment of the invention, information related to products, services, hybrid products and services, subjects of commerce, or any other item(s) of trade (IOT) or components thereof (symbolically referred to herein as “IOT information”), whether tangible or intangible, are stored in database 32 (particularly in storage unit 32b), preferably segmented into data records with each data record corresponding to a single intellectual property. In an exemplary embodiment, the stored IOT information may include: a) any identifying information such as internal/external identification numbers (e.g., catalog numbers), names (e.g., trade names, brand names), part numbers, component lists, etc.; b) any textual descriptive information such as textual abstracts, technical papers, manuals, marketing texts, etc.; c) graphical descriptive information such as brochures, drawings, pictures, illustrations, blue prints, etc.; d) any multimedia descriptive information such as audio clips, video clips, animations, etc.; or e) any other descriptive information related to or otherwise pertinent to a product, service, or other IOT (e.g., logs, reports, etc.). In storing the IOT information, different drawings or other descriptions of the IOT may be assigned to different levels in a hierarchical (or other) arrangement. The levels may be assigned, for example, such that the first or top level provides the IOT as a whole or the most comprehensive description of the IOT, and the last or low level provides the most elemental or fundamental description of a component making up the IOT.

In accordance with a preferred embodiment of the invention, information related to an analysis of intellectual property information, IOT information, or both is stored in database 32 (particularly in storage unit 32c), preferably segmented into data records. In an exemplary embodiment, the stored analysis information may include: a) any (objective or subjective) technical analysis such as qualitative/quantitative test data and review of results, observations and evaluations by technicians, skilled artisans, or experts, prior art search results, etc.; b) any legal analysis such as citation, review or commentary on statutory, regulatory, common, territorial, and case law, etc.; c) interpretative analysis such as legal conclusions drawn from application of law to (technical, legal, or other) facts (e.g., with respect to patents: claim construction, infringement/non-infringement determination, validity/invalidity determination, right-to-use, design around, etc.; and similarly with respect to other forms of intellectual property); and d) any other material including or supporting analysis (e.g., written opinions, exhibits, attachments, documentary material considered, etc.).

In accordance with a preferred embodiment of the invention, the storage units 32a, 32b, and 32c respectively containing intellectual property information, IOT information, and analysis information may be used separately, all together, or in various combinations. For simplification, only an exemplary embodiment utilizing all three broad categories of information (and their corresponding storage units) together is described herein. One or more of the three storage units 32a, 32b, and 32c may be initialized, filled, added to/subtracted from, updated, or otherwise populated manually (by one or more users) utilizing user interface 35 (or any other module). The storage units may also be populated automatically as part of an initial loading, periodically, or arbitrarily as needed. Both acts of manual and automatic population may draw from any one or more sources of information. For example, information may be imported from existing documents, files, or other records; created (e.g., word processor, scanner, fax, camera, audio/video capture, etc.) and stored; or returned from searching (e.g., from internal or external resources such as IPO module 304, Internet data sources, etc.).

In an exemplary embodiment, population of database 32 may occur through importing known information from existing sources or user input (e.g., via user interface 35 or other devices) or retrieved from (internal/external) sources using search engine 312. For example, IPO module 304 may be used as a source of known intellectual property information on a first company (e.g., owner of the system) or second company (e.g., competitor). Other unknown information, such as information on competitor products that may not yet be known by a user of the system can be retrieved based on search criteria or queries formulated in server 30 and/or by user 35. Search engine 312 may, for example, provide text-based, graphics-based, code-based, or other search/query mechanisms to produce search results to be viewed, accessed, or otherwise output from server 30 (e.g., to user 35). In an exemplary embodiment, search engine 312 performs searches based on input data such as: identification numbers (e.g., model number); keywords; text or graphics; Boolean logic characters; or other search criteria (e.g., date restrictions, etc.).

Results of the search or query are compiled for storage, display, or other output (e.g., to user 35). The results may include a list of intellectual property, IOT, analysis or other information corresponding to the search criteria or query developed by (or input to) server 30. The information listed may link to underlying data (e.g., images, text, etc.) stored locally or remotely in a database, may be links to resources on remote storage systems (e.g., government/industry database, Web site of commercial database provider, etc.) accessible over an external network (e.g., network 37), or may be other links or data identifying a location or resource (on or off-line) of information (e.g., name of printed publication, name/address of publisher, or identity of thesis cataloged in library, etc.) corresponding to the search criteria or query. Search engine 312 is programmed to permit editing or refinement of the search criteria or query to perform additional searches on different data sets or the data set produced from the initial search results.

Server 30 makes the search results (and any available underlying items listed) available for viewing or other output (e.g., print, e-mail, fax, etc.) by user 35 (or other systems). In accordance with a preferred embodiment, the resulting information (e.g., results and/or available underlying documents) may be downloaded in one or more textual, graphical, multimedia or other formats (e.g., DOC, RTF, PDF, PPT, TIFF, JPG, GIF, BMP, MPG, AVI, WMV, etc.), or set for alternative delivery to one or more specified locations (e.g., via e-mail, fax, regular mail, courier, etc.) in any desired format (e.g., print, storage on electronic media such as CD-ROM, etc.). Server 30 is programmed to allow users to view one or more documents or items on the same display (e.g., in user interface 35), as well as view one or more portions or segments or information fields of different documents (e.g., abstract, drawings, etc.) simultaneously (or substantially simultaneously) so as to facilitate analysis.

Search results, the underlying documents/items listed in the search results, as well as the search criteria itself may be saved (in local or remote memory units). In a preferred embodiment, users are provided with dedicated workspace areas in which to save, edit and organize saved search results, resulting documents, search criteria, and results of any other analysis operation. Workspace module 314 is provided (alone or in conjunction with other modules) to facilitate and control use of the workspace areas by individuals or groups of individuals. Workspace module 314 permits the creation and naming of portfolios or other folder mechanisms that may be useful in the retention and organization of the information stored in database 32. Select documents (or portions of data records), search results, search criteria, and other information may be moved into different folders for storage and organization purposes. The folders may be organized into different hierarchical arrangements where desired. Users are permitted to annotate individual documents, search results, criteria, as well as folders with notes, comments, and identification data for their own use or group usage. The annotations may themselves include the introduction, importation or link (e.g., URLs) to a variety of information, including documents, images, video, multimedia context, and other data available or stored locally or remotely through the network.

During data population (or anytime thereafter), identifier module 306 (alone or in conjunction with other modules) is programmed to be used to categorize or index individual data records of storage units 32a, 32b, 32c by placing tags, labels, designators or other identifiers in the individual data records themselves. Alternatively (or in addition), the identifiers may be separately stored (locally/remotely) but maintained in association with the individual data records (e.g., using pointers, indexes, or other correlating devices). The identifiers may be placed automatically or manually and may take any form (e.g., textual, graphical, static, dynamic, etc.). Although the identifiers may be utilized in all (or only in portions (or none at all)) of the data records stored in storage units 32a, 32b, 32c, for simplification, only an exemplary embodiment applying identifiers to various intellectual property stored in storage unit 32a will be discussed in detail herein. Exemplary identifiers may include company, division, technology, product, component, method/process, license agreement, region, litigation, assigned attorney, country, or any other default or user-defined category.

In accordance with a preferred embodiment of the invention, report generator 308 may be provided for use (alone or in conjunction with other modules) in providing reports and other output resulting from operation of server 30. The reports may be output to user interface 35 (or other destination) in any human or machine perceptible form (e.g., video display, print out, e-mail, Web page, text/graphic file, fax, charts, graphs, etc.), and may include the underlying listed items (or references to access the listed items). Among other things, report generator 308 is programmed to respond to a request for output of a report listing of intellectual property (or other type of stored information) containing one or more desired identifiers. Reports may thus be utilized, for example, to provide listings of intellectual property for a given product, technology, division, or other desired category, in various assortments and formats.

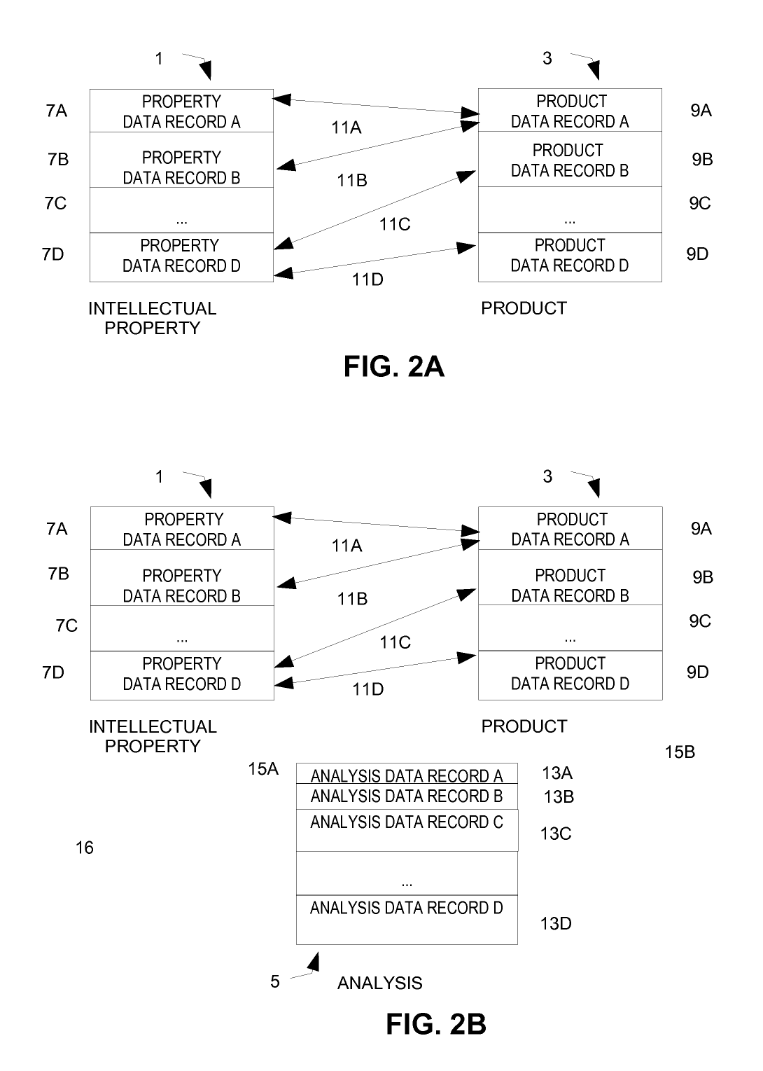

In accordance with a preferred embodiment of the invention, linking module 310 is provided to implement (alone or in conjunction with other modules) the creation, definition, or other assignment of an association, correlation, or other linked relationship between (or among) individual intellectual property, IOT, and analysis information (in any desired combination) stored in database 32. FIGS. 2a and 2b are representational diagrams illustrating exemplary linked relationships of the information stored (e.g., in database 32). As shown in FIG. 2a, for example, the intellectual property information 1 and the product information 3 are linked, preferably backward and forward linked. In accordance with this exemplary embodiment, the product data record may be associated, correlated , or otherwise linked logically (or otherwise) as symbolically shown by link 11 to one or more intellectual property data records to which it relates. Likewise, a given intellectual property data record can be linked to one or more product data records to which there is an association, correlation or other relationship. Thus, a user may search for and retrieve data on a particular intellectual property, for example a given patent, from the intellectual property information 1 and retrieving, viewing or otherwise following the link(s) 11 from the given intellectual property data record 7, determine all of the product data records 9, if any, in the product information 3 relevant to the given patent data record. Thus, a user may search for a particular product in the product information 3, and following the link(s), determine the data record(s) 7 and thus the patents, if any, in the intellectual property information 1 relating to the product.

Similarly, as shown in FIG. 2b, property data records 7 or product data records 9 may be (forward/backward) linked via link 15 to one or more analysis data records 13 in the analysis information 5. Additionally, the analysis information itself may be (forward/backward) linked to one or more intellectual property data records in the intellectual property information 1, or product data records in the product information 3 via link 16.

Linking module 310 may be programmed to effect the linked relationship using any known logical, physical, software or hardware mechanism to associate one or more data records together. Linking module 310 may, for example, rely on the use of special identifiers (e.g., assigned through identifier module 306) in one (or in all) of the mutually related data records to define the respective relationship (e.g., a “first product” identifier assigned to a “second intellectual property” data record to define the link between a first product and a second intellectual property). Linking module 310 may alternatively (or in conjunction with the use of identifiers) utilize pointers, indexes, link lists, or other auxiliary tables or memory devices to establish the association or relationship between (or among) data records.

As an illustration, one utility of the linking relationship can be seen from the following exemplary implementation of an analysis system in accordance with a preferred embodiment of the invention. In this exemplary illustration, a user (e.g., corporate counsel) has (previously) manually linked (e.g., through operation of linking module 310) a company's portfolio of piano patents (e.g., as reflected in the intellectual property data records stored in storage unit 32a) with a given piano product manufactured by the company (e.g., as reflected in the IOT data records stored in storage unit 32b). The same (or different) user now desires to analyze the patent protection afforded the company's piano product. In accordance with this exemplary illustration, the user may retrieve and view (e.g., using user interface 35) the IOT data record pertaining to the given piano product. In this exemplary illustration, it is assumed that the data record is populated with multiple drawing or graphical views. The views are arranged for display or processing in a hierarchical order from a first (or topmost) level depicting the product as a whole (e.g., 3-D drawing of the piano as completely constructed) to the last (or lowermost) level depicting the most elemental component (e.g., uncoiled string, unlaminated keys, etc.) used to construct the piano product.

Each view selected for display (e.g., on user interface 35) depicts the piano product or one of its varying levels of component parts. An indication (e.g., reference numeral or symbol, pop-up text box, or other textual/graphical indicia) on the display is presented to indicate that the product or component is linked with one or more intellectual property data records (as well as any IOT data records and/or analysis data records). Depending on the implementation of the user interface 35, the user can select one or more of the linked data records for simultaneous (or substantially simultaneous) viewing (e.g., on the same or another display screen of a multiple-display unit) or switched viewing to display the underlying patent(s) (e.g., design patent on the piano as a whole, competitor's utility patents on piano, etc.) and/or analysis (e.g., legal interpretation of the patent claim) information represented by the linked data records. As the user changes views (e.g., keyboard level) of the product, different data records (e.g., patent on the lamination used on the keys) linked to the product/components depicted in the views will become accessible to the user.

In accordance with a preferred embodiment, all (or select) users may enter notes, comments, analysis, or other annotations with respect to data records or portions thereof. The annotations may be submitted in any form, including text, graphic, data identification, as well as importation of or links to (e.g., URLs) a variety of information, including documents, images, video, multimedia context, and other data available or stored locally or remotely through the network. In the exemplary illustration provided above, for example, the user may be permitted to annotate patent drawings or claim phrases with personal comments or analysis (e.g., claim interpretation from user's perspective). In a preferred embodiment, the annotations are recorded as portions of or separate analysis data records linked to the subject of annotation (e.g., patent). As a result, when the patent data record is subsequently viewed or otherwise accessed by the same (or different) user, an indication that the annotation has been linked to the patent (or portion thereof) is readily apparent to the user.

In accordance with a preferred embodiment, the access to certain annotations (or analysis information) may be controlled (e.g., for only individual, executive or supervisory level access). In this exemplary embodiment, security restrictions may be imposed by server 30 (or other modules) to certain users (or user interfaces 35) that prohibit the viewing of indications (or mere access) of annotations by other users (e.g., restrictions to attorney eyes only, peer level users may not have access to annotations from other users of the same level, inputting user viewing only, etc.). In accordance with an exemplary embodiment, the restriction on viewing annotations may be for all levels until a master data record with only one (or more) select annotation(s) is provided for access generally by all users. In this exemplary embodiment, for example, a supervisor may wish to review all annotations before selecting one (or more) that are worthy of general access. Server 30 may further be programmed to track the identities (e.g., through digital signatures or other secured identification) of all users providing annotations, and track the identities corresponding to the annotations actually selected by the supervisor for general access. Statistical and other reports may be issued accordingly from report generator 308.

Report generator 308 may also be programmed to generate analysis reports in any form. An exemplary listing of some possible reports include patent claims analysis, validity analysis, infringement analysis, doctrine of equivalents analysis, design-around analysis, invention disclosure analysis, exhibit preparation analysis, foreign filing analysis, or other user-defined analysis reports. Report generator 308, for example, may be programmed to allow users to create and store templates or other forms to be populated during report generation. The templates may include any textual, graphical, or other content stored or otherwise referenced in database 32 (or in any other local or remote memory unit) for retrieval and placement in the report as dictated by the template.

Various pre-established report templates may be utilized to facilitate the reporting functions. In the patent claims analysis report, for example, report generator 308 is programmed to output a claim chart analysis template that displays in chart form one or more claims (and claim phrases) vis-à-vis an IOT (e.g., a product) that is the subject of an infringement/non-infringement analysis. The claim chart template may be populated from information input from a user (or other source), as well as from information stored in the intellectual property, IOT, and analysis data records in storage units 32a, 32b, 32c, respectively. Once populated, the claim chart analysis template may be viewed, printed, or otherwise output by report generator 308, as desired by the user. The claim chart analysis may also be stored (e.g., in database 32) for subsequent use, updating (manually or automatically), etc. Other analysis report templates may be prepared and populated in a similar manner from input from a user (or other source), as well as from data records stored in database 32.

Report generator 308 may also be programmed to generate reports in the form of opinion documents (e.g., written legal opinions). Necessary opinion templates may be created and utilized to form the basic format or skeleton of an opinion (e.g., letter format as preferred by an individual user). In accordance with this exemplary embodiment, report generator 308 populates the opinion template with user input (or input from other sources) and information from the pertinent intellectual property, IOT, and analysis data records. During the initial drafting of an infringement opinion, for example, report generator 308 may automatically generate a draft opinion using the preferred opinion template (based on user selection). Report generator 308 may incorporate, for example, in the opinion a summary description and sample drawing of the subject patent from the pertinent intellectual property data record stored in storage unit 32a. Report generator 308 may further include a description and perspective illustration of the subject product from the pertinent IOT data record stored in storage unit 32b. Report generator 308 may also, if available, incorporate pertinent analysis information including case law summaries of pertinent case law, as well as any technical and interpretative analysis that may be pertinent for inclusion in the opinion. To the extent any claim chart analysis report had already been prepared and stored in the system, report generator 308 may incorporate the claim chart analysis in the draft opinion. Once initially populated, the report generator 308 can output the draft opinion for viewing, printing, storing and editing (e.g., in a user's workspace). The opinion thus created can be stored (e.g., in database 32) and associated with one or more data records (e.g., intellectual property data records, IOT data records, etc.). Automatic (or manual) updates of the opinion can be produced through updates of the intellectual property, IOT and/or analysis information used to populate the opinion.

While preferred embodiments of the invention have been described and illustrated, it should be apparent that many modifications to the embodiments and implementations of the invention can be made without departing from the spirit or scope of the invention. For example, although the specific illustrations provided herein may have pertained to intellectual property in the form of patents, it should be apparent to those of ordinary skill in the art that the invention may similarly be employed to information related to any form or combination of intellectual property (e.g., (design, plant, utility) patents, trademarks, copyrights, mask works, plant varieties, trade secrets, know-how/know-not-how, or other equivalent or related intellectual property such as certificates, registrations, etc., as well as provisional, pending, or abandoned applications for intellectual property protection (e.g., patent applications) and confidential/privileged material such as invention disclosures/reports, lab notebooks, documentation of conception, reduction to practice, diligence, etc.). The use of the term “intellectual property” information in the various embodiments described herein should be readily construed to include the underlying information constituting intellectual property information (e.g., patents, publications, etc.), as well as the numerical, textual, graphical or other indicia identifying the intellectual property information itself, or such indicia identifying the location where such intellectual property information may be retrieved, stored, accessed, located or otherwise found.

Although not specifically mentioned, it should be readily apparent that IPO module 304 is described herein symbolically as a reliable source for supplying updated intellectual property information. Like all other modules described herein, the invention is not limited to the use (or lack thereof) of IPO module 304. Indeed, IPO module 304 may be used instead of or in conjunction with search engine 312. Search engine 312 may employ search technology (e.g., spiders, worms, bots, or other known devices) used to access information in (or through) IPO module 304 as well as from local/remote database systems (or other memory units) over any internal or external network (e.g., the Internet) to perform the various functions of retrieving, accessing, searching, etc. for stored information. Similar modules may be used as reliable sources for supplying information related to items of trades (e.g., of one or more competitor companies or industries, etc.) or analysis information (e.g., case law updates, statutory/regulatory changes, etc.).

In the exemplary embodiments described above, the association, correlation or other relationship represented by the “link” between (or among) intellectual property, IOT, and analysis information is not restricted to data record-to-data record relationships. “Linked” relationships may be established between and among data records within the same category (e.g., among intellectual property information such as all of the members of a patent family linked together for each individual member of the patent family), as well as between portions of data records (e.g., link between claim XX of a patent data record and video clip of a product data record, etc.) between different or the same information categories.

The information stored in database 32 (e.g., intellectual property information, IOT information, analysis information) may be stored in their natural states as the underlying documents, files, or other items they represent in their individual data records. The information may also be stored (in lieu of or in conjunction with the underlying items) as hyperlinks, pointers, indexes, or other references to underlying data (e.g., images, text, etc.) stored locally or remotely in one or more databases, may be links to resources on remote storage systems (e.g., government/industry database, Web site of commercial database provider, etc.) accessible over an external network (e.g., network 37), or may be other links or data identifying a location or resource (on or off-line) of information (e.g., name of printed publication, name/address of publisher, or identity of thesis cataloged in library, etc.). Moreover, the invention is not restricted to the use of only the broad categories of information stored in database 32 (e.g., intellectual property information, IOT information, analysis information). More (or less) categories may be stored, linked, processed, and analyzed as needed for any given implementation of the invention.

While a client-server architecture has been specifically illustrated herein, the invention may easily be deployed in any form of network or other communication technology, as well as an analyzer in the form of a stand-alone computer system (e.g., desktop, laptop, etc.). While the illustrated embodiments have not specified the type of communication medium (or protocol) used to connect the various modules (e.g., shown in FIG. 1), it should be apparent that any known wired/wireless technology may be used to implement the invention (e.g., PCI bus, firewire, USB, Internet, intranets, private bulletin boards, individual local or wide area networks, proprietary chat rooms, ICQ, IRC channels, instant messaging systems, WAP, Bluetooth, Fibre Channel, etc.) using real-time or non-real-time systems alone or in combination. The embodiments described in (or apparent from) the instant disclosure may be employed in stand-alone (or network linked) systems. The embodiments may similarly be implemented in other known systems and platforms (e.g., personal computer, Internet-based devices, PDAs, portable or hand-held electronic devices, etc.).

In accordance with a preferred embodiment, one or more user interfaces (e.g., user interface 35 (FIG. 1)) are provided as part of (or in conjunction with) the illustrated systems to permit users to interact with the systems. User interface devices may be any device used to input and/or output information. The user interface device may be implemented as a graphical user interface (GUI) containing a display or the like, or may be a link to other user input/output devices known in the art. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described. The illustrated embodiments have further been described in connection with one or more “users.” It should be readily apparent that a “user” of the various aspects of the inventive systems or methods disclosed or apparent herein may be individuals, entities, devices, as well as peer/non-peer systems or technologies, and modules within the same device (e.g., server 30) or system without departing from the scope of the invention.

The modules described herein, particularly those illustrated or inherent in the instant disclosure, may be one or more hardware, software, or hybrid components residing in (or distributed among) one or more local or remote computer systems. Although the modules may be shown or described herein as physically separated components (e.g., CPU 300, memory 302, IPO 304, identifier module 306, report generator 308, linking module 310, search engine 312, workspace module 314, etc.), it should be readily apparent that the modules as described herein are merely logical constructs that are implemented as physical devices that may be omitted, combined or further separated into a variety of different components, sharing different resources (including processing units, memory, clock devices, software routines, etc.) as required for the particular implementation of the embodiments disclosed (or apparent from the teachings herein). Indeed, even a single general purpose computer (or other processor-controlled device) executing a program stored on an article of manufacture (e.g., recording medium (e.g., CD-ROM) or other memory units) to produce the functionality referred to herein may be utilized to implement the illustrated embodiments.

In addition, memory, storage or database units described herein may be logical or physical constructs and may be any one or more of the known storage devices or systems (e.g., Random Access Memory (RAM), Read Only Memory (ROM), hard disk drive (HDD), floppy drive, zip drive, compact disk-ROM, DVD-ROM, bubble memory, redundant array of independent disks (RAID), network accessible storage (NAS) systems, etc.), may also be one or more memory devices embedded within a CPU, or shared with one or more of the other components, and may be deployed locally or remotely relative to one or more components interacting with the memory, storage or database units.

For simplicity, preferred embodiments of the invention have been described herein primarily in terms of implementations in the form of an apparatus. It should be readily apparent, however, that the preferred embodiments may be similarly implemented in the form of a method of performing the operations specifically described (or apparent from) the disclosures made herein.

Accordingly, the invention is not to be limited by the foregoing description or drawings, and only by the claims appended hereto.

What is claimed is:

1-25. (canceled)

26. A method for linking information regarding intellectual property, items of trade, and technical, legal or interpretive analysis, comprising:
storing, in a computer processor device, intellectual property information in a plurality of IP data records respectively corresponding to individual intellectual property;
storing, in the computer processor device, IOT information concerning an item of trade (IOT), the IOT information being information regarding at least one of products and services, the IOT information being stored segmented into data records with each data record linked to a single intellectual property in the IP data records;
storing, in the computer processor device, a technical, legal or interpretive analysis, the technical, legal or interpretive analysis being stored segmented into data records with each data record linked to a single intellectual property in the IP data records;
associating, in the computer processor device, the stored intellectual property information with the stored IOT information and the stored technical, legal or interpretive analysis,
wherein
the data records in the IOT information are forward and backward linked so a user can search the IOT database, and follow a link in the data records returned as search results to the IP data records that correspond to the IOT, and
the data records in the technical, legal or interpretive analysis are forward and backward linked so a user can search the technical, legal or interpretive analysis, and follow a link in the data records returned as search results to the IP data records that correspond to the IOT.

27. The method of claim 26, wherein the IOT records are searchably indexed by company and division.

28. The method of claim 26, wherein the IOT records are searchably indexed by technology, product and component.

29. The method of claim 26, wherein the IOT records are searchably indexed by license agreement and region or country.

30. The method of claim 26, wherein the IOT records are searchably indexed by litigation and region or country.

31. The method of claim 26, wherein different drawings or descriptions of the IOT are assigned different levels in a hierarchical arrangement from a top level for the IOT as a whole to a lowest level which is a most elemental description of a component in the IOT, wherein IP data records linked to search results of an IOT database search or a technical, legal or interpretive analysis search are presented in a hierarchical view corresponding to the hierarchical arrangement of the IOT.

32. A system, implemented on at least one computer, for linking information regarding intellectual property, items of trade, and technical, legal or interpretive analysis, comprising:
a storage interface; and
a processor cooperatively operable with the storage interface, the processor being configured to
store intellectual property information in a plurality of IP data records respectively corresponding to individual intellectual property;
store IOT information concerning an item of trade (IOT), the IOT information being information regarding at least one of products and services, the IOT information being stored segmented into data records with each data record linked to a single intellectual property in the IP data records;
store a technical, legal or interpretive analysis, the technical, legal or interpretive analysis being stored segmented into data records with each data record linked to a single intellectual property in the IP data records;
associate the stored intellectual property information with the stored IOT information and the stored technical, legal or interpretive analysis,
wherein
the data records in the IOT information are forward and backward linked so a user can search the IOT database, and follow a link in the data records returned as search results to the IP data records that correspond to the IOT, and
the data records in the technical, legal or interpretive analysis are forward and backward linked so a user can search the technical, legal or interpretive analysis, and follow a link in the data records returned as search results to the IP data records that correspond to the IOT.

33. The system of claim 32, wherein the IOT records are searchably indexed by company and division.

34. The system of claim 32, wherein the IOT records are searchably indexed by technology, product and component.

35. The system of claim 32, wherein the IOT records are searchably indexed by license agreement and region or country.

36. The system of claim 32, wherein the IOT records are searchably indexed by litigation and region or country.

37. The system of claim 32, wherein different drawings or descriptions of the IOT are assigned different levels in a hierarchical arrangement from a top level for the IOT as a whole to a lowest level which is a most elemental description of a component in the IOT, wherein IP data records linked to search results of an IOT database search or a technical, legal or interpretive analysis search are presented in a hierarchical view corresponding to the hierarchical arrangement of the IOT.

38. A computer program stored on a non-transitory computer-readable medium with a method for linking information regarding intellectual property, items of trade, and technical, legal or interpretive analysis, the program comprising computer-executable steps for:
storing, in a computer processor device, intellectual property information in a plurality of IP data records respectively corresponding to individual intellectual property;
storing, in the computer processor device, IOT information concerning an item of trade (IOT), the IOT information being information regarding at least one of products and services, the IOT information being stored segmented into data records with each data record linked to a single intellectual property in the IP data records;
storing, in the computer processor device, a technical, legal or interpretive analysis, the technical, legal or interpretive analysis being stored segmented into data records with each data record linked to a single intellectual property in the IP data records;
associating, in the computer processor device, the stored intellectual property information with the stored IOT information and the stored technical, legal or interpretive analysis,
wherein
the data records in the IOT information are forward and backward linked so a user can search the IOT database, and follow a link in the data records returned as search results to the IP data records that correspond to the IOT, and
the data records in the technical, legal or interpretive analysis are forward and backward linked so a user can search the technical, legal or interpretive analysis, and follow a link in the data records returned as search results to the IP data records that correspond to the IOT.

39. The computer program of claim 38, wherein the IOT records are searchably indexed by company and division.

40. The computer program of claim 38, wherein the IOT records are searchably indexed by technology, product and component.

41. The computer program of claim 38, wherein the IOT records are searchably indexed by license agreement and region or country.

42. The computer program of claim 38, wherein the IOT records are searchably indexed by litigation and region or country.

43. The computer program of claim 38, wherein different drawings or descriptions of the IOT are assigned different levels in a hierarchical arrangement from a top level for the IOT as a whole to a lowest level which is a most elemental description of a component in the IOT, wherein IP data records linked to search results of an IOT database search or a technical, legal or interpretive analysis search are presented in a hierarchical view corresponding to the hierarchical arrangement of the IOT.
